(19) United States
(12) Patent Application Publication
(10) Pub. No.: US 2009/0251883 A1
(43) Pub. Date: Oct. 8, 2009

(54) Light-emitting device as well as lighting apparatus and display apparatus using the same

(75) Inventors: Yukio Yamasaki, Osaka (JP); Katsuhiko Kishimoto, Nara-shi (JP)

Correspondence Address: HARNESS, DICKEY & PIERCE, P.L.C., P.O. BOX 8910, RESTON, VA, 20195, US

(73) Assignee: SHARP KABUSHIKI KAISHA

(21) Appl. No.: 12/382,282

(22) Filed: Mar. 12, 2009

(30) Foreign Application Priority Data
Mar. 13, 2008 (JP) 2008-064604(P)

(51) Int. Cl. F21V 9/16

(52) U.S. Cl. 362/84

(57) ABSTRACT

A light-emitting device including a semiconductor laser element having at least a substrate, a first conductive type clad layer, an active layer, and a second conductive type clad layer in this order; and a phosphor absorbing a laser light emitted from the semiconductor laser element and radiating fluorescence, wherein the semiconductor laser element is a self-oscillation laser element.

This nonprovisional application is based on Japanese Patent Application No. 2008-064604 filed on Mar. 13, 2008 with the Japan Patent Office, the entire contents of which are hereby incorporated by reference.

### BACKGROUND OF THE INVENTION

1. Field of the Invention

The present invention relates to a light-emitting device having a semiconductor laser element and a phosphor, and more specifically, to a light-emitting device usable as a lighting apparatus or a display apparatus.

2. Description of the Background Art

In recent years, light-emitting devices using a semiconductor light-emitting device and a phosphor have been developed as substitutes for conventional light-emitting devices such as an incandescent lamp and a fluorescent lamp. As one example of the semiconductor light-emitting device, a light-emitting diode including a light-emitting layer of group III-V compound semiconductor can be recited, and light-emitting diodes emitting a light in red, green, as well as blue have been brought into practical use. A light-emitting device using a light-emitting diode has features of small size, low cost, less power consumption and a long life that have not been realized by conventional lighting apparatuses. However, since the light-emitting device using a light-emitting diode cannot have such a large optical output as comparable to that of an incandescent lamp or a fluorescent lamp, it is mostly limited to be used for illumination, indicator or the like as a lighting apparatus, and used in a back light of a display or the like as a display apparatus at present.

As the semiconductor light-emitting device, a light-emitting device using a semiconductor laser element composed of a group III-V compound semiconductor is also devised. Japanese Patent Laying-Open No. 7-282609 discloses a light-emitting device including a semiconductor laser element and a phosphor that converts diffused laser beams from the lens into a visible light as an excitation light.

As the semiconductor laser element used in the light-emitting device, there exist a type that emits a white light by a fluorescent light resulting from a laser light absorbed in and converted into a phosphor by using a semiconductor laser element that emits an violet or blue-violet laser light having a wavelength of 390 to 420 nm and a phosphor in which materials for phosphor emitting red to blue fluorescence are blended, and a type that emits a white light combining the laser light from a semiconductor laser element and a fluorescent light from a phosphor by using a semiconductor laser element that emits a blue laser light having a wavelength of 420 to 500 nm and a phosphor in which materials for phosphor emitting green to red fluorescence are blended.

Japanese Patent Laying-Open No. 7-282609 describes an example that uses an array-type semiconductor laser element in the aforementioned light-emitting device. For realizing functionality as a light-emitting device, it is often required that the semiconductor laser element has an output of generally 1 watt or higher. However, in a semiconductor laser element of a single stripe structure, a light output of as small as about several hundreds mW or less is obtainable due to optical damage in a semiconductor material. Therefore, by using an array-type semiconductor laser element having a plurality of stripes, it is possible to realize a high output operation of as high as several watts.

### SUMMARY OF THE INVENTION

However, in a conventional light-emitting device using a semiconductor laser element, the following problems exist.

When the array-type semiconductor laser element is used, since the laser light outgoes from a plurality of light-emitting points, the plurality of laser beams interfere with each other and interference fringe arises in the outgoing light. It is practically undesirable to use a light-emitting device using such a semiconductor laser element, as a lighting apparatus or a display apparatus, because unevenness in light emission is caused.

Major part of the laser light released from the semiconductor laser element is applied on the phosphor, and a part thereof is taken outside the light-emitting device after wavelength conversion, and a part thereof is taken outside the light-emitting device after penetration through the phosphor, while the remainder is reflected on the phosphor and a part thereof again enters inside the semiconductor laser element. Further, when a transparent glass is present between the semiconductor laser element and the phosphor, or when a reflective surface such as a screen is present outside the light-emitting device, the laser light is also reflected by these, and a part thereof enters again inside the semiconductor laser element.

Such a light is refereed to as “a return light” and is a cause of making a laser oscillation operation, or an optical output of the semiconductor laser element unstable. When such a light-emitting device is used as a lighting apparatus or a display apparatus, it may result in unevenness in light emission and is not practically desirable.

In a light-emitting device of a type using a semiconductor laser element that emits a blue laser light having a wavelength of 420 to 500 nm, a part of the laser light is converted into a light having a wavelength of red to green by the phosphor and produces a white light together with the laser light, however, in this type, since the laser light emitted from the semiconductor laser element is used as the light from the light-emitting device, the outgoing light produces glaring (speckle pattern) peculiar to the laser light caused by the coherence of the laser light. When such a light is used as a light source of a lighting apparatus or a display apparatus, it may cause unevenness in light emission and is not practically desirable.

All of the above problems arise due to the laser light from the semiconductor laser element having coherence. As a countermeasure, the coherence may be reduced by conducting high frequency superposition for modulating an injection current toward the semiconductor laser element. In order to realize this, however, it is necessary that a power circuit for supplying the semiconductor laser element with power have high frequency superposition function, and this is practically undesirable because cost rise and size increase of the light-emitting device may result.

Further, in the light-emitting device, high uniformity of an emission spectrum (color rendering index) is required in the visible wavelength band that spans from 400 nm to 700 nm. In a light-emitting device of a type using a semiconductor laser element that emits the blue laser light having a wavelength of 420 to 500 nm, since the laser light is used as a light from the light-emitting device, the emission spectrum spanning the visible wavelength band from the light-emitting device takes an steep shape in the blue wavelength band, leading the problem of very poor color rendering index.

In the light of the aforementioned problem, it is an object of the present invention to provide a light-emitting device, a lighting apparatus and a display apparatus in which the laser light of low coherence is produced even in a light-emitting device using a power circuit not having a high-frequency superposition function, and the color rendering index of emitting light is improved.

As a result of diligent effort, the present inventors have found that the above problem can be solved by using a self-oscillation laser element in a light-emitting device. That is, the present invention is as follows.

The present invention provides a light-emitting device including a semiconductor laser element having at least a substrate, a first conductive type clad layer, an active layer, and a second conductive type clad layer at least in this order; and a phosphor that absorbs laser light emitted from the semiconductor laser element and radiates fluorescence, wherein the semiconductor laser element is a self-oscillation laser element.

Here, the self-oscillation (semiconductor) laser element used in the present invention is a laser element in which an outgoing laser light blinks in a short cycle by the element alone. Structure of the self-oscillation semiconductor laser element is not particularly limited insofar as it causes self-oscillation, and for example, a structure having a region referred to as a saturable absorbing layer (S.A.) in the vicinity of an active layer can be recited. When a saturable absorbing layer is provided in the vicinity of an active layer, the saturable absorbing layer serves to conduct absorption and release of the laser light generating in the active layer, so that the outgoing laser light blinks in a short cycle. In other words, it is possible to obtain the same effect as that obtainable by superposing high frequency current on the single mode laser, by the element alone in the self-oscillation laser element. As a result, it is possible to reduce the return light and weaken the coherence of the laser light.

The self-oscillation laser element of the present invention produces an effect of the present invention insofar as the self-oscillation occurs in the semiconductor laser element at the time of operation of the light-emitting device, and besides the aforementioned structure, an weakly index guided (WI) structure may also be employed wherein a saturable absorbing region is provided inside the active layer by setting light confinement in the direction perpendicular to a layer thickness be in an intermediate condition between index guide and gain guide.

Preferably, the self-oscillation (semiconductor) laser element of the present invention includes a nitride semiconductor. The nitride semiconductor is a semiconductor based on nitrogen, and is not particularly limited insofar as it is usable in the self-oscillation laser element, and examples thereof include InGaN, AlGaN and GaN.

In the present specification, InGaN means a semiconductor mainly containing In (indium) and Ga (gallium) and N (nitrogen), wherein 99% or more of the composition is occupied by these three elements. The description In_{0.07}Ga_{0.93}N means that the ratio of In and Ga contained in the semiconductor is 0.07:0.93 (the same is true for AlGaN and GaN).

Preferably, the self-oscillation laser element of the present invention has an oscillation wavelength of 390 to 500 nm.

Preferably, the semiconductor laser element of the present invention has at least a first conductive type intermediate layer and a first conductive type saturable absorbing layer between the first conductive type clad layer and the active layer from the side closer to the active layer.

Preferably, the semiconductor laser element of the present invention has at least a second conductive type intermediate layer and a second conductive type saturable absorbing layer between the active layer and the second conductive type clad layer, from the side closer to the active layer.

Preferably, in the light-emitting device of the present invention, the semiconductor laser element is an array-type semiconductor laser element, or has two or more semiconductor laser elements. Further, the light-emitting device of the present invention is particularly useful when there is a combination where a wavelength difference is 1 nm or less in the laser light from a plurality of light emitting points.

The substrate of the self-oscillation semiconductor laser element used in the light-emitting device of the present invention is not particularly limited, and an n-GaN substrate, a sapphire substrate, an AlN substrate, a SiC substrate and the like can be recited, and an n-GaN substrate is preferred.

According to the present invention, since the coherence of the laser light can be weakened in the light-emitting device using the semiconductor laser element and the phosphor, it is possible to suppress the phenomenon undesirable for the light-emitting device such as interference fringe or light unevenness of the outgoing light. In addition, it is possible to obtain a light-emitting device capable of maintaining the outgoing light having a higher output and better stability than a conventional one.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of an embodiment in the light-emitting device of the present invention.

FIG. 2 is a block diagram showing a configuration of a second embodiment of the light-emitting device according to the present invention.

FIG. 3 is a schematic section view showing the light-emitting device of Example 1.

FIG. 4 is a section view of the self-oscillation semiconductor laser of Example 1, viewed from the stripe direction.

FIG. 5 is an explanatory view of the S.A. system in Example 1.

FIG. 6 is a self-oscillation wavelength obtained in a measurement, imaged with a digital camera.

FIG. 7 is a view showing far field patterns of the present and conventional light-emitting devices.

FIG. 8 is a view showing relative intensity noise (RIN), with respect to a return light in the present and conventional light-emitting devices.

FIG. 9 is a schematic view showing a method of measuring an oscillation wavelength for a light emission point position of a self-oscillation semiconductor laser element.

FIG. 10 shows an example of a plot of an oscillation wavelength with respect to the light emission point position, using a measuring system shown in FIG. 9, for a conventional type light-emitting device using a non-self oscillation semiconductor laser element having three emission points.

FIG. 11 is a section view of the self-oscillation semiconductor laser element of Example 2, viewed from the stripe direction.

FIG. 12 is a view showing the S.A. system structure of the present invention.

FIG. 13 is a schematic section view showing the light-emitting device of Example 3.

FIG. 14 is a view showing an emission spectrum of the light-emitting device according to the present invention.

FIG. 15 is a schematic section view showing the light-emitting device of Example 5.

### DESCRIPTION OF THE PREFERRED EMBODIMENTS

Hereinafter, in the drawings of the present application, an identical reference numeral denotes an identical part or a corresponding part. Dimensional relations such as length, size and width in drawings are appropriately changed for clarity and simplification of drawings, and do not represent actual dimensions.

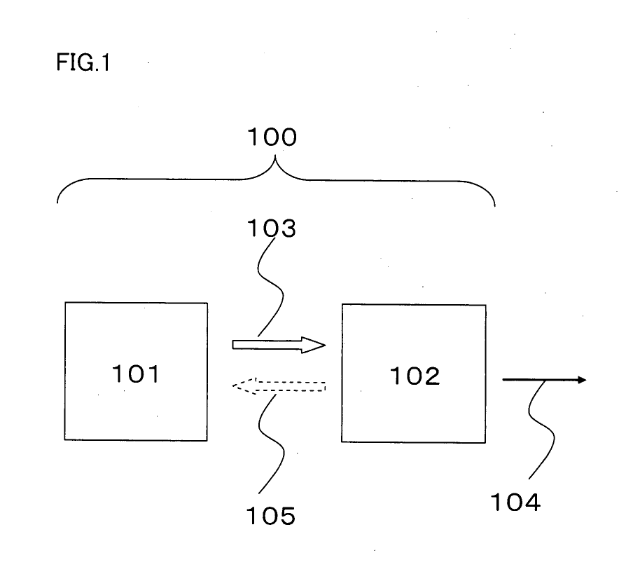

FIG. 1 is a block diagram showing configuration of an embodiment in the light-emitting device of the present invention.

In the following, the embodiment of the present invention will be described with reference to FIG. 1.

A light-emitting device 100 in the present invention includes a self-oscillation semiconductor laser element 101, and a phosphor 102. The self-oscillation semiconductor laser element and the phosphor are arranged so that a laser light 103 emitted from the self-oscillation semiconductor laser element is absorbed in the phosphor. The laser light absorbed by the phosphor is converted into a fluorescent light 104 by the phosphor and taken outside of the light-emitting device.

In the light-emitting device of the present invention, since the self-oscillation semiconductor laser element is used, and the coherence of the laser light is low, there exerts an effect that even when the self-oscillation semiconductor laser element is an array-type self-oscillation semiconductor laser element, or has two or more self-oscillation semiconductor laser elements, and there is a combination in which a difference in wavelengths of the laser lights from individual light emission points is 1 nm or less, these laser light beams will not interfere with each other, and interference fringe will not occur in the outgoing light.

Further, even when a part of the laser light is reflected by the phosphor or the like, and there is a light that enters the self-oscillation semiconductor laser element again, namely a return light 105, there exerts an effect that it is possible to prevent a laser oscillation operation, namely an optical output from becoming unstable because the self-oscillation semiconductor laser element is used, and the coherence of the laser light is low in the light-emitting device of the present invention.

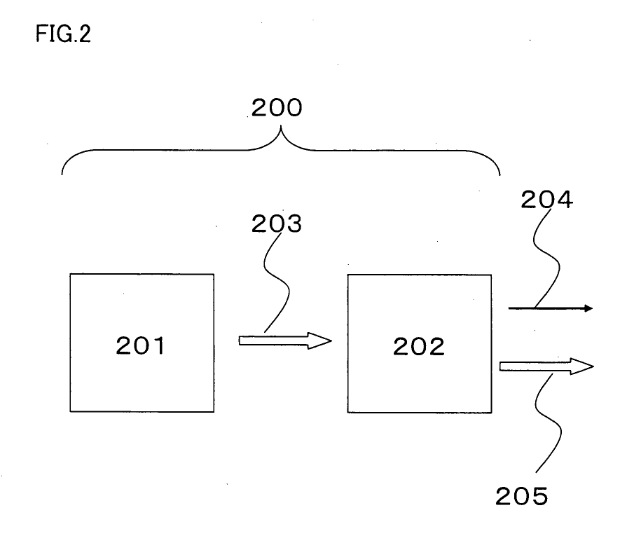

FIG. 2 is a block diagram showing a configuration of a second embodiment in the light-emitting device of the present invention. In the following, the second embodiment of the present invention will be described with reference to FIG. 2.

A light-emitting device 200 in the present invention includes a self-oscillation semiconductor laser element 201 having an oscillation wavelength of 420 to 500 nm, and a phosphor 202. Then, the self-oscillation semiconductor laser element and the phosphor are arranged so that a laser light 203 emitted by the self-oscillation semiconductor laser element is absorbed by the phosphor. The laser light absorbed by the phosphor is converted into a fluorescent light 204 by the phosphor, and is taken outside of the light-emitting device. A part of a laser light 205 is not absorbed by the phosphor and transmits through the phosphor, and is taken outside of the light-emitting device. In other words, in the light-emitting device of the second embodiment, white the light being produced by combining the fluorescent light by the phosphor and a part of the transmitted laser light. (Although the return light is present in FIG. 2, illustration thereof is not given.)

In the light-emitting device of the second embodiment, the following effect exists in addition to the aforementioned effect.

In the light-emitting device of the second embodiment, since the coherence of the laser light is low, a speckle pattern peculiar to the laser light caused by the coherence is reduced.

While the light-emitting device of the second embodiment produces a white light by combining the fluorescent light and a part of the laser light, it also improves color rendering index of the white light because a self-oscillation semiconductor laser element is used and the spectrum of the laser light is widened compared to the conventional light-emitting device.

### Example 1

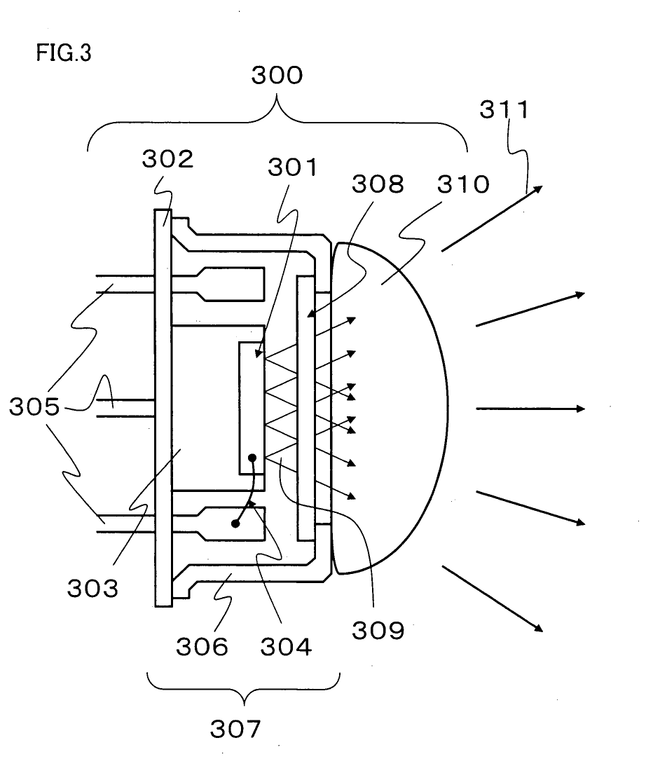

FIG. 3 is a schematic section view of the light-emitting device according to Example 1.

An array-type self-oscillation semiconductor laser element 301 is mounted on a block 303 that is formed integrally with a stem 302. The array-type self-oscillation semiconductor laser element is connected with a pin 305 that is formed integrally with the stem via a wire 304, and the array-type self-oscillation semiconductor laser element can be energized by supplying electric power to the pin from outside of the light-emitting device. The array-type self-oscillation semiconductor laser element is arranged inside a space 307 that is hermetically sealed by a cap 306. However, the cap is provided with a transmission window 308 made of a glass, and as a result, a laser light 309 emitted from the array-type self-oscillation semiconductor laser element is released outside the hermetically sealed space through the transmission window. Further, a phosphor 310 is arranged outside the cap, and the phosphor is irradiated with most of the laser light, where the laser light is absorbed and converted into a fluorescent light 311, and released outside.

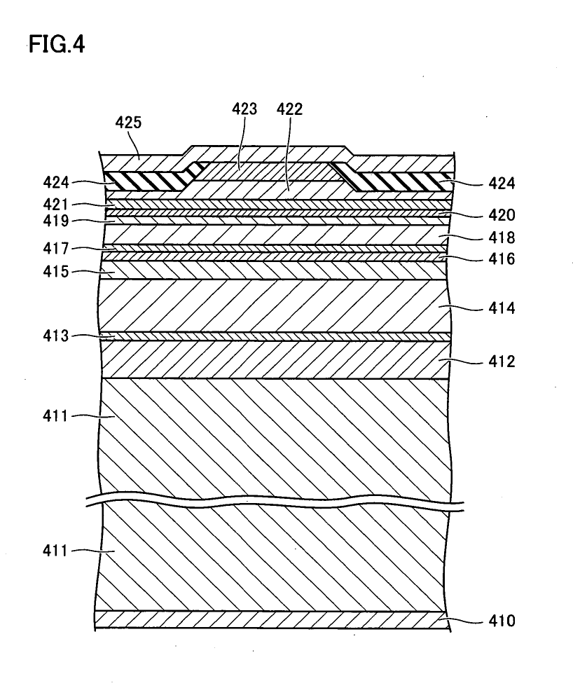

FIG. 4 is a section view of a nitride semiconductor laser element which is a self-oscillation semiconductor laser element of Example 1, viewed from the stripe direction.

The nitride semiconductor laser element has a structure having a P-type saturable absorbing layer, and has, from the side of the substrate, an N electrode 410, an n-GaN substrate 411, an n-GaN layer 412, an n-InGaN crack preventive layer 413, an n-AlGaN clad layer 414, an n-GaN guide layer 415, an n-InGaN active layer 416, a first C.E. of p-AlGaN 417, a second C.E. of InGaN 418, an S.A. of InGaN 419, a third C.E. of InGaN 420, a p-GaN guide layer 421, a p-AlGaN clad layer 422, a p-GaN contact layer 423, an insulation film 424, and a P electrode 425.

In the context of the present specification, “S.A.” indicates a saturable absorbing layer, and “C.E.” indicates a carrier extinction layer (the same is true for below).

As shown in FIG. 4, the self-oscillation semiconductor laser element of Example 1 is a self-oscillation semiconductor laser element having a refractive index waveguide using a ridge structure. The first C.E. of p-AlGaN is also effective as a carrier block layer for preventing overflow of injected electrons.

<Production Method of Example 1>

In the following, a production method of the light-emitting device according to Example 1 will be described with reference to FIG. 3 and FIG. 4.

The term “epitaxial growth method” described in the present specification means a method for making a crystal film grow on a substrate, and examples thereof include a VPE (vapor phase epitaxial) method, a CVD (chemical vapor phase deposition) method, an MOVPE (metal organic vapor phase epitaxial) method, an MOCVD (metal organic chemical vapor deposition) method, a Halide-VPE (halogen chemical vapor phase epitaxial) method, an MBE (molecular beam epitaxial) method, an MOMBE (metal organic molecular beam epitaxial) method, a GSMBE (gas source molecular beam epitaxial) method, and a CBE (chemical beam epitaxial) method.

First, a gallium nitride semiconductor layer is caused to grow epitaxially on GaN substrate 411. A GaN substrate is set in a MOCVD apparatus, and a low-temperature GaN buffer layer is caused to grow to 25 nm at growth temperature of 550° C. by using NH₃ which is a group V material and TMGa which is a group III material (not shown). Then SiH₄ is added to the above materials at growth temperature of 1075° C. to form 3 μm of n-GaN layer 412 (Si impurity concentration 1×10¹⁸/cm³). Sequentially, the growth temperature is decreased to about 700° C. to 800° C., and a group III material of TMIn is supplied, and 50 nm of n-In_{0.07}Ga_{0.93}N crack preventive layer 413 is formed. Again, the substrate temperature is raised to 1075° C., and n-Al_{0.07}Ga_{0.93}N clad layer 414 (Si impurity concentration 1×10¹⁸/cm³) having a thickness of 2.0 μm is caused to grow by using a group III material of TMAl, and sequentially 0.1 μm of n-GaN guide layer 415 is caused to grow.

n-AlGaN clad layer 414 is not limited to that described above, and may be a uniform layer having a mixed crystal ratio of about 0.03 to 0.020, or may be composed of a plurality of layers having different mixed crystal ratios, or may be a layer in which the mixed crystal ratio continuously changes, and may have a different layer thickness. It is important that radiation loss to the n-GaN substrate is sufficiently controlled. As for n-GaN guide layer 415, it is not limited to that described above, and it should be changed for optimizing the light confinement coefficient and the FFP pattern of the active layer, but is not determined uniquely. In particular, some crystalline In may be mixed, or may be undoped (Si impurity concentration 1×10¹⁷/cm³ or less), and the layer thickness may be different.

Thereafter, the substrate temperature is lowered to 730° C., and active layer (multi-layered quantum well structure) 416 made up of four cycles of an In_{0.08}Ga_{0.92}N well layer having a thickness of 4 nm and an In_{0.02}Ga_{0.98}N barrier layer having a thickness of 8 nm is caused to grow in the order of a barrier layer/a well layer/a barrier layer/a well layer/a barrier layer/a well layer/a barrier layer. Between a barrier layer and a well layer, or between a well layer and a barrier layer, the growth may be suspended for 1 second to 180 seconds. This improves flatness of each layer, and reduces a width of an emission half band. While Si is added as impurities to the active layer, both of the barrier layer and well layer may be undoped (Si impurity concentration 1×10¹⁷/cm³ or less), or either one of them may be undoped. Not limited to three cycles, the active layer may be a SQW (single quantum well), or may have about 2 cycles to 12 cycles, and desirably 3 cycles to 6 cycles.

Next, the substrate temperature is raised again to 1050° C., and first C.E. of p-Al_{0.3}Ga_{0.7}N 417 having a thickness of 18 nm is caused to grow. As a p-type impurity, 5×10¹⁹/cm³ to 2×10²⁰/cm³ of Mg was added thereto. It is preferred that first C.E. of p-Al_{0.3}Ga_{0.7}N 417 is from 5 nm to 40 nm, and may also have such a structure that Al composition reduces in the p layer direction, or may be a combination of at least one layer having different Al compositions. When the thickness of first C.E. of p-Al_{0.3}Ga_{0.7}N 417 is smaller than 5 nm, threshold rises due to carrier overflow.

Next, the substrate temperature is lowered to 730° C., 2 nm of second C.E. of In_{0.02}Ga_{0.98}N 418 is caused to grow, and sequentially, 1 nm of S.A. of In_{0.10}Ga_{0.90}N 419, and 2 nm of third C.E. of In_{0.02}Ga_{0.98}N 420 are caused to grow. These layers were added with 1×10¹⁷/cm³ to 2×10²⁰/cm³ of Mg as a p-type impurity, however, they may be undoped (meaning that Mg impurity concentration is 1×10¹⁷/cm³ or less, but small amounts of additives resulting from diffusion from the other layer and residual gas at the time of growth are contained), or individual layers may have different impurity concentrations. However, since subsequent absorption is impossible and self-oscillation cannot be continued unless electrons generating by absorption of a light by S.A. are alleviated in a short time, it is preferred that the S.A. has increased Mg impurity concentration compared to the neighboring C.E.

When the thickness of the S.A is 4 nm or less which is comparable with or thinner than exciton Bohr radius, the substantial band gap of the S.A. can be examined by the photoluminescence PL measurement or the absorption spectrum of a wafer. At 4 nm or thicker, it is desired to observe the absorption spectrum of the wafer. This is because localization of a carrier by an internal electric field is influenced. The substantial band gap of the active layer and the substantial band gap of the S.A. are adjusted such that they are generally equal to each other by making the difference between these band gaps fall within −0.15 eV to +0.02 eV in the results of above measurements. After stacking the S.A. and the C.E., the growth may be suspended for 1 second to 180 seconds.

Subsequently, 0.095 μm of pGaN guide layer 421, 0.5 μm of p-Al_{0.1}Ga_{0.9}N clad layer 422, and 0.1 μm of p-GaN contact layer 423 are caused to grow while the substrate temperature is raised again to 1050° C. 5×10¹⁹/cm³ to 2×10²⁰/cm³ of Mg was added thereto as a p-type impurity.

As described above, as materials for elements and dope elements constituting individual layers, TMGa (trimethyl gallium), TMAl (trimethyl aluminum), TMIn (trimethyl indium), NH₃, Cp₂Mg (bisethylcyclopentadienyl magnesium), and SiH₄ are used.

After the formation of p-GaN contact layer 423, a ridge structure is formed by dry etching, and insulation film 424 made of SiO₂ is provided in the site other than the ridge structure, and on the top face thereof, P electrode 425 (Pd/Mo/Au) is formed. Insulation film 424 may be formed of Ta₂O₅, SiO, TiO₂, ZrO₂, Al₂O₃ or the like without being limited to SiO₂, or may be a mixed body or a layer structure of two or more of these materials. An absorptive material such as Si may be used to form a loss guide structure. A ridge width may be about 1 μm to 20 μm, and a modulation ridge structure or a taper ridge structure not having a constant width is also acceptable.

Thereafter, a part of the substrate is removed from the rear surface side of the GaN substrate by polishing or etching, and the thickness of the wafer is adjusted as thin as about 70 to 300 μm. This is a step for facilitating splitting of the wafer into individual laser chips in the subsequent step. In particular, when a laser end face mirror is also formed at the time of splitting, it is desired that the thickness is adjusted to as small as about 70 to 120 μm. In the present embodiment, the thickness of the wafer was adjusted to 100 μm by using a grinder and a polisher. Only a polisher may be used. Rear surface of the wafer is flat because it is polished by a polisher.

After polishing, a thin metal film is vapor deposited on the rear surface of GaN substrate 411 to provide N electrode 410. this N electrode 410 has a layer structure of Hf/Al/Mo/Pt/Au. The vacuum vapor deposition is suited for forming such a thin metal film with excellent controllability of the film thickness, and in Example 1 of the present invention, this technique was used. However, other technique such as an ion plating method or a sputtering method may be used. In order to improve characteristics of the P, N electrodes, annealing is conducted at 500° C. after the formation of the metal film to obtain a good Ohmic electrode. Annealing of the N electrode is conducted after vapor deposition of Hf/Al, and Mo/Pt/Au may be metalized after the annealing.

The semiconductor device manufactured in the manner as described above is split in the following manner. First, scribe lines are given by a diamond point from the front surface side where the active layer is present, and the wafer is split along the scribe lines by application of appropriate force on the wafer. The scribe lines may also be given from the rear surface side. Chip splitting may also be achieved similarly by using other techniques such as a dicing method in which scratching or cutting is conducted using a wire saw or a thin-sheet blade, a laser scribing method in which a crack is made in a radiated part by heat radiation of the laser light such as excimer laser, and subsequent quenching, and the crack acts as a scribe line, and a laser ablation method in which a radiated part is evaporated by irradiation with the laser light of high energy density, and thereby grooving process.

Outgoing rear surface may be coated with a high reflecting film (HR). As is well known, the high reflecting film is obtained by alternately stacking a low refractive index material and a high refractive index material at a thickness of ¼ of the optical wavelength λ, and in the present embodiment, four pairs (8 layers) made up of SiO₂/TiO₂ was used. As a result, reflectance of the rear surface is increased to about 95%.

Also, outgoing front surface may be coated with a low reflecting film (AR). As is well known, a low reflecting film is obtained by stacking a low refractive index material at a thickness of about ¼ of the optical wavelength λ, and is able to reduce the reflectance to about 0.5%.

Next, a split self-oscillation semiconductor laser element was mounted on a heat sink by a die bonding method. The self-oscillation semiconductor laser element was bonded by a solder or the like in a junction down manner in which the side of P electrode is a joining surface. The heat sink used herein refers to a block of stem. As a material of the solder, for example, AuSn (Sn=20%) or SnAgCu is used. Here, a sub mount may be arranged between the self-oscillation semiconductor laser element and the heat sink as is necessary. This is provided in response to a request of electrically separating the self-oscillation semiconductor laser element and the heat sink, or the like. As a material of the sub mount, a high heat conductive material such as SiC, AlN, Si, Cu, Cuw or a diamond is used.

Next, the self-oscillation semiconductor laser element and a lead are electrically connected by a wire. Electrical connection may be achieved by stretching a wire such as Au line between these components, for example, with the use of a wire bond device.

Next, the self-oscillation semiconductor laser element is hermetically sealed with a cap. This is intended to prevent the semiconductor material, the solder material, the electrode material, and the wire bonding part from being exposed to air such as moisture for making the light-emitting device endurable to long term use in a practical environment. As such a method, there are well known methods, for example, a ring welding method for a case of a small cylindrical cap, and a seam welding method and a laser welding method for a case of a large package.

Lastly, a phosphor was arranged outside the transmission window of the cap. As the phosphor, for example, yttrium-aluminum-garnet (YAG) phosphor (yellow), α-SiAlON:Eu (yellow), β-SiAlON:Eu (green), CaAlSiN3:Eu (red), silicon oxynitride compound containing cerium (blue) and the like are recited. There is a case where may be used singly or in mixture, and selected depending on use application and requested specification of the lighting apparatus and the display apparatus. In the present example, as an example of combination excellent in high efficiency and high color rendering index, a combination of silicon oxynitride compound containing cerium (blue), β-siAlON:Eu (green), α-SiAlON:Eu (yellow) and CaAlSiN₃:Eu (red) is employed.

Yamada et al. has theoretically discussed that a carrier life time of a saturable absorbing body is an important parameter for obtaining a self-oscillation semiconductor laser utilizing a saturable absorption characteristic (IEIC.E. Trans, Electron, vol.E81-C, 1998). In a nitride semiconductor using InGaN in an active layer, InGaN is also used in a saturable absorbing layer (S.A.) used as a saturable absorbing body. In general, in a nitride semiconductor laser using InGaN in an active layer, a double hetero structure using both GaN and AlGaN is employed.

The band gap in each bulk is in the order of InGaN, GaN and AlGaN from the smaller one, and the lattice constant is in the order of InGaN, GaN and AlGaN from the larger one. There is often a case where growth temperature in epitaxial growth is about 800° C. or less for InGaN, and about 1000° C. for GaN and AlGaN.

In the following, description will be given for a S.A. system that uses a nitride semiconductor laser where three kinds of materials having such characteristics are combined, and is able to appropriately control the carrier life time.

In the present specification, the “S.A.” represents a saturable absorbing layer, and the “S.A. system” includes a layer that is in the vicinity of the S.A. and influences on the saturable absorbing characteristic of the S.A., as well as the S.A. In the present specification, a S.A. system utilizing internal electric field, and a S.A. system utilizing recombination of a defect in a hetero interface or the like will be described.

<As for Internal Electric Field>

In the epitaxial growth layer using the above three kinds of materials, a large internal electric field arises by mutual distortions. In general, an internal electric field has a piezoelectric effect and intrinsic polarization, and the inclination of band bending is roughly determined by the material. The S.A. that determines the substantial absorption characteristic of the S.A. system is made of InGaN, and the composition In(x) of the contained In is large relative to the neighboring layer. Since this S.A. has larger lattice constant than a peripheral layer structure, the compression distortion arises. Usually, gallium nitride-based semiconductor has a growth surface in the direction of the c surface, and grows with Ga rich. In a gallium nitride-based semiconductor having p-n junction, the S.A. formed of InGaN having the distortion exhibits band bending so that the energy decreases in the direction of the P layer (generally it is often the growing direction). This bending direction is similar to that of a case where forward biasing is made between a P electrode and a N electrode provided in a gallium nitride-based semiconductor.

In these gallium nitride-based semiconductors, there is often a case where a GaN substrate or a sapphire substrate is used as the substrate, and the lattice constant of these substrates is smaller than that of InGaN, so that the S.A. laminated on the substrate undergoes compression distortion.

On the other hand, as for InGaN in which composition of In is small, and as for AlGaN in which compositions of Al and GaN are small, the bending direction differs depending on the condition of a peripheral layer. Further, as for AlGaN in which composition of Al is large, the band bending occurs in such a manner that the energy increases in the direction of the P layer, however, it is necessary to take an internal applied electric field into account during an operation of the semiconductor laser. It was found that the S.A. system that is specific for the nitride semiconductor can be constructed by appropriately utilizing these features.

<Carrier Extinction Layer (C.E.)>

In order to rapid relaxation of a carrier of the S.A., it is possible to tunnel a small amount of carriers to a carrier extinction layer (C.E.) by utilizing the effect of the internal electric field as described above (Path_B).

In the present specification, since the layers other than the S.A. in the S.A. system are used for extinction of carriers in the S.A. regardless of directly or indirectly, all of these layers are referred to as C.E. (carrier extinction layer). The details will be described later.

Taking a carrier life time of the C.E. by tunnel effect as τC.E., a layer thickness of the C.E. as dC.E., tunneling probability as τt, a recombination time in the S.A. as τS.A., and a layer thickness of the S.A. as dS.A., when τt is sufficiently small,

τS.A.′=dS.A./(dC.E./τC.E.+dS.A./τS.A.) is satisfied, and for example, when τS.A.=τC.E. and 2×dS.A.=dC.E.,

τS.A.′=τS.A./3 is satisfied.

When τC.E. is sufficiently rapid, or when dC.E. is sufficiently thick, description may be made as follows:

τS.A.′=1/(1/τS.A.+1/τt).

For shortening the carrier life time of the C.E., recombination at a hetero interface between the C.E. and AlGaN may be used. As will be described later, it can be expected that recombination by a defect or the like is promoted, because change in growth temperature is large, and the lattice constant is different at InGaN/AlGaN hetero interface.

In order to increase the tunneling probability from the S.A. to the C.E., it is desired that there is a level that allows distribution of the carriers generating in the well layer to ooze out to the C.E. and to tunnel to the C.E. When the layer thickness of the S.A., dS.A., is smaller than exciton Bohr radius, distribution of the carriers generating by absorption ooze out of S.A. Thus it was found that width of an S.A. well layer made of InGaN is desirably 4 nm or less, and 3 nm or less is particularly preferred.

On the other hand, for example, in S.A. having large band bending, since the energy decreases in the direction of P layer as described above, the carrier distribution is deviated in the P layer direction when minority carrier is electron, while the carrier distribution is deviated in the substrate direction when minority carrier is hole. In the S.A. made up of distorted quantum well having such large band bending, it is considered that the carrier distribution ooze out to the C.E. in the P layer direction and the substrate direction, respectively, even when the layer thickness is 4 nm or larger. However in the S.A. made up of distorted quantum well, the substantial band gap decrease due to the band bending is large, and it is necessary to make composition In(x) of In relatively small.

In order to obtain tunnel effect to C.E., it is desired that the band bending occurs, also in C.E. likewise in S.A., such that the energy decreases in the P layer direction, and an AlGaN layer may be provided in the vicinity of the C.E. Higher composition of Al is desired, and 0.1 or higher and 0.15 or higher is further desired.

At the time of the forward biasing, an external electric field acts so that the band bending of the S.A. is large. By making the S.A. and the C.E. non doped, it is possible to make the effect of the external electric field remarkable. As a result, tunnel effect from the S.A. to the C.E. is expected at the time of laser operation even if a built-in tunnel effect is not expected.

<Interface Recombination>

Besides the effect of the band bending, it is expected that the carrier life time of the S.A. can be reduced by recombination of AlGaN/InGaN hetero interface (Path_C). It was found that recombination by a defect or interface level at the interface is expected because significant discontinuity in growth temperature is added to the mismatch of the lattice constant at the hetero interface described above. Since the carrier distribution of the S.A. has broadness comparable with exciton Bohr radius, the rapid relaxation of the carrier is expected by a defect at the hetero interface and a tunnel effect to an interface level when the above hetero interface is present at a very close position.

In order to increase the oozing of carrier distribution from the well layer, it is desired that the width of the S.A. layer made of InGaN is 4 nm or less, and particularly 3 nm or less. On the other hand, for example, in the S.A. made up of distorted quantum well having large band bending, the energy decreases in the P layer direction as described above. When minority carrier is electron, since the carrier distribution is deviated in the P layer direction, the hetero interface may be present in the vicinity of the S.A. in the P layer direction, and when minority carrier is hole, since the carrier distribution is deviated in the substrate direction, the hetero interface may be present in the vicinity of the S.A. in the substrate direction. In the S.A. made up of such distorted quantum well, reduction of the carrier life time can be expected even if the width of the well is 4 nm or more.

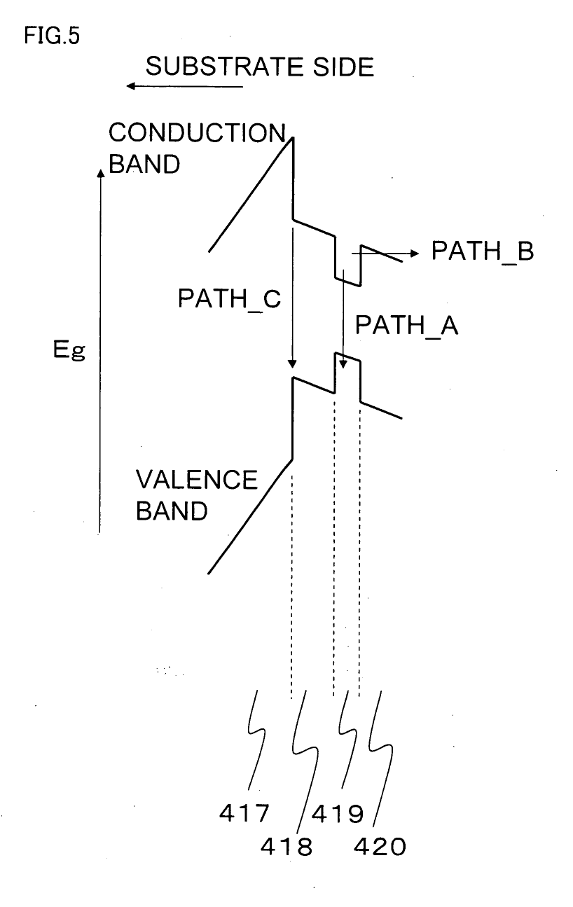

FIG. 5 is an explanatory view of the S.A. system in Example 1.

FIG. 5 shows that a first C.E. of AlGaN 417, a second C.E. of InGaN 418, an S.A. of InGaN 419, and a third C.E. of InGaN 420 are provided from the side of an N electrode of the S.A. system.

As shown in FIG. 5, relaxation paths of electrons include relaxation in S.A. 419 (Path_A), relaxation at first C.E. 417/second C.E. 418 hetero interface (Path_C), and relaxation by tunneling from S.A. 419 to third C.E. 420 (Path_B). Path_A includes radiation recombination and non-radiation recombination. In this manner, by controlling Path_B and Path_C, a S.A. system peculiar to a nitride semiconductor laser can be constructed.

In the S.A. system shown in FIG. 5, the S.A. is arranged on the P layer side, however, similar effect is expected regardless of whether the S.A. is arranged on the side of the P layer or the N layer. In the P layer, the tunnel effect of an electron is important because a hole is a majority carrier. In the N layer, the tunnel effect of a hole is important for the self-oscillation because an electron is a majority carrier.

In Example 1, layer thicknesses and the like of second C.E. 418, S.A. 419, and third C.E. 420 are examined.

In order to use Path_C, it is necessary to utilize the broadness of an electron, and distance from center of the S.A. to first C.E. layer 417 should be comparable with exciton Bohr radius, and it is considered that

dC.E.2+dS.A./2≦10 nm is preferred, and

dC.E.2+dS.A./2≦4 nm is more preferred.

Second C.E. 418 is made of InGaN or GaN, and composition of In is preferably about 0 to 0.05. Further, growth temperature of second C.E. 418 is preferably 830° C. or less.

In order to use Path_B, smaller distance from first C.E. 417 to third C.E. 419 is preferred, and it is necessary that lattice relaxation does not occur. Although it is difficult to distinguish between effects of Path_B and Path_C, in Example 1 it was confirmed that self-oscillation occurred when dC.E.2+dS.A.≦15 nm. dC.E.2+dS.A.≦5 nm was more preferred. Within the above range, the nitride semiconductor laser is easy to obtain self-oscillation, and a self-oscillation characteristic can be controlled by appropriately adjusting the layer thickness.

The S.A. is preferably 4 nm or less which is comparable with exciton Bohr radius, and is not less than 0.5 nm. At 0.5 nm or less, the S.A. is not regarded as a layer because of aggregation of In in the S.A. However, even with S.A. having a thickness of larger than 4 nm, it is possible to obtain self-oscillation because the second C.E. is thin and distortion of the S.A. is large when dC.E.2+dS.A.≦15 nm is satisfied.

Therefore, in S.A. system structure 2,

dC.E.2+dS.A.≦15 nm is preferred, and

dC.E.2+dS.A.≦5 nm is more preferred.

In Example 1, second C.E. 418 of InGaN may be GaN; a thin layer of GaN may be inserted between first C.E. of AlGaN 417 and second C.E. of InGaN 418; GaN may be inserted between second C.E. of InGaN 418 and S.A. of InGaN 419; third C.E. of InGaN 420 may be GaN, and GaN may be inserted between S.A. of InGaN 419 and third C.E. of InGaN 420.

In Example 1, it is presumable that the S.A. and the C.E. promote the effect of Path_B because they undergo compression distortion from the substrate. In order to obtain such an effect, it is desired that the lattice constant of the substrate is smaller than the lattice constants of S.A. and C.E., and specifically, it may be equal to or smaller than that of GaN. As the substrate, for example, a sapphire substrate or sapphire into which a small amount of element other than Al and O (oxygen) is mixed to form a mixed crystal, and an AlGaN substrate into which an element other than Ga and N is mixed to form a mixed crystal can be recited.

Self-oscillation frequency may be adjusted by changing optical cavity length and end surface reflectance because it can be changed by photon life time.

The effect of the present invention can be expected even when layers other than the S.A. system in the nitride semiconductor laser are different from those described above. For example, an AlGaN clad layer having a multi-layer structure, an SLS clad, an InGaN guide layer and the like can be recited. Between the active layer and the first C.E., an InGaN layer or a GaN layer may be present.

Identically, in the nitride semiconductor laser provided with such a S.A. system, photon lifetime in the optical cavity is one of the principal factors that determine the self-oscillation characteristic. As a method of elongating the photon life time, for example, an attempt of increasing end surface reflectance, extending the optical cavity length, and reducing the internal loss are effective. In particular, since reflectance and optical cavity length can be readily changed, they may be changed in the final step of manufacturing the nitride semiconductor laser. Further, the smaller the internal loss possessed by the nitride semiconductor laser, the better the self-oscillation characteristic can be obtained even with the short optical cavity length. The larger the reflectance of the front surface and rear surface possessed by the nitride semiconductor laser, the better the self-oscillation characteristic can be obtained even with the short optical cavity length. However, when the reflectance of the front surface is increased, it becomes difficult to take out the laser light from the front surface, and an optical output width allowing the self-oscillation is apparently narrowed.

Taking these into account, the optical cavity length is 150 nm or more, preferably 300 nm or more and more preferably 450 nm or more, and the reflectance of the rear surface is preferably 70% or more. On the other hand, the reflectance of the front surface is preferably 5 to 60%. When the reflectance of the front surface is more than 60%, an apparent optical output width allowing self-oscillation is narrow, whereas when the reflectance is less than 5%, photon life time is short, and self-oscillation is difficult to occur.

Various characteristics of the light-emitting device thus manufactured were examined. The optical cavity length of the self-oscillation semiconductor laser element was 650 μm, stripe width was 5 μm. At room temperature of 25° C., continuous oscillation was effected at a current threshold of about 60 mA, and an oscillation wavelength was 390 to 420 nm. FFP (far field pattern) lacks ripple and the like, and has no trouble in the light focusing by a lens or the like. It is estimated that the oscillation occurs in a basic lateral mode. Next, it was found that light waveform was observed using a high-speed light receiving device and an electric oscilloscope at a constant optical output of 100 mW (APC drive), and self-oscillation was observed. Presence or absence of the self-oscillation may also be detected by observation with the use of an electric spectrum analyzer or an optical oscilloscope.

### Test Example 1

### Imaging of Self-Oscillation Waveform

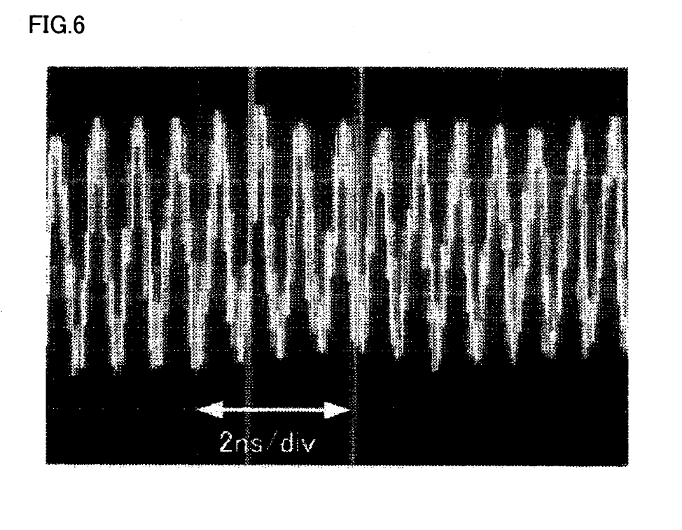

FIG. 6 shows a self-oscillation waveform of Example 1 obtained by a measurement, imaged with a digital camera. A pulse current is used at the time of a measurement, and a pulse width is 1.8 μS, and a duty ratio is 1%, and the waveform measures 2 ns/div by oscilloscope.

Next, the self-oscillation and the optical output at that time were examined with varied injection current, and self-oscillation was observed up to about 500 mW. It is possible to achieve self-oscillation up to about 1W by adjusting the front and back reflectance and on the like.

Examination with other material has revealed that it is necessary that linear inclination gain of the S.A. is high, and the carrier life time is short for achieving the self-oscillation of the semiconductor laser. In the nitride semiconductor, since photon energy is high because of the wavelength of as short as 400 nm, and the material is different from the above case, new research is obviously required to achieve the characteristics as described above.

### Test Example 2

### Verification of Interference Fringe

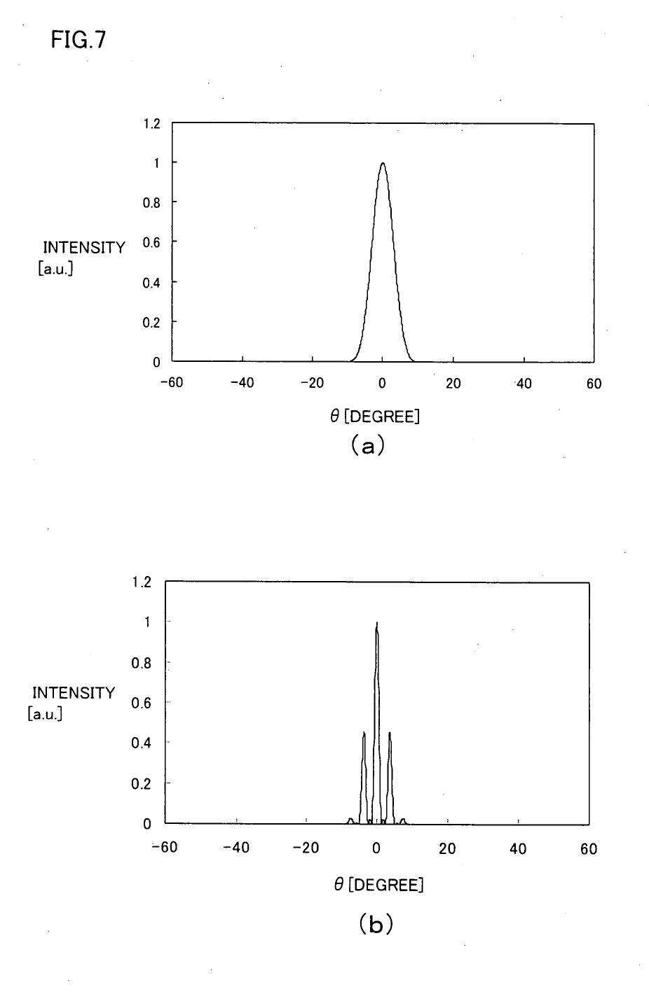

FIG. 7(a) shows a far field pattern in the condition that a phosphor is absent in the light-emitting device according to Example 1 on which a 3 array-type self-oscillation semiconductor laser element is mounted. FIG. 7(b) shows a far field pattern in a conventional light-emitting device, namely in a light-emitting device using a semiconductor laser element lacking self-oscillation (semiconductor laser element not having S.A.) as a semiconductor laser element. Here, the far field pattern is obtained by scanning from the direction perpendicular to the light emitting surface of the self-oscillation semiconductor laser element to the direction parallel with the substrate surface.

As seen from FIG. 7, the far field pattern in the light-emitting device of Example 1 has a single peak shape, while in the conventional light-emitting device, an interference fringe occurs, and the pattern exhibits a multi peak shape. This results from the fact that coherence is reduced because the light-emitting device of the present invention uses a self-oscillation semiconductor laser element, and the laser light released from a plurality of light emitting points do not interfere with each other, and is truly the effect of the present invention.

### Test Example 3

### Relative Intensity Noise with Respect to Return Light Quantity

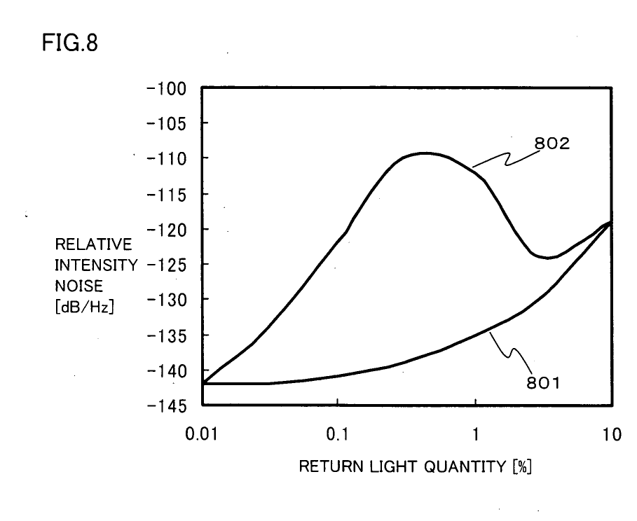

FIG. 8 shows an example of a measurement of relative intensity noise (RIN) with respect to return light quantity. 801 indicates a measurement for the light-emitting device according to Example 1, and 802 indicates a measurement for a conventional light-emitting device, namely in a light-emitting device using a semiconductor laser element lacking self-oscillation (semiconductor laser element not having the S.A.) as a semiconductor laser element, and both of these show measurement results in the condition that a phosphor is absent.

As seen from FIG. 8, RIN in the light-emitting device of the present invention is lower than that in the conventional light-emitting device. This is because in the light-emitting device of the present invention, the coherence is reduced owing to use of the self-oscillation semiconductor laser element, and noise intensity contained in the optical output by the return light is reduced. Therefore, even when a phosphor is provided, relative noise by reflection at the phosphor surface, namely noise intensity in the emission intensity is presumed to be lower in the light-emitting device of the present invention than that in the conventional light-emitting device.

### Test Example 4

### Measurement of the Oscillation Wavelength for Light Emitting Point Position of Self-Oscillation Semiconductor Laser Element

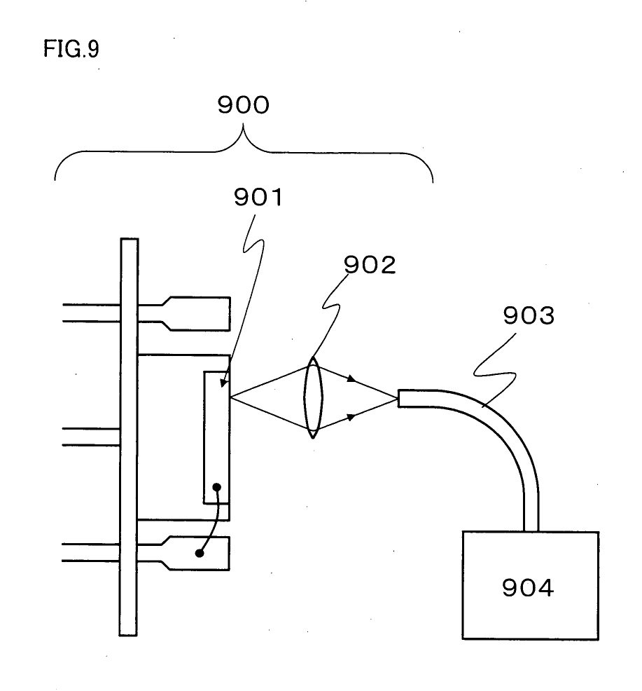

FIG. 9 is a schematic view showing a method of measuring the oscillation wavelength for light emitting point position of the self-oscillation semiconductor laser element. A light-emitting device 900 has such a structure that a phosphor and a cap part are removed from the light-emitting device shown in FIG. 3. In the condition that the light-emitting device is supplied with electric power and laser oscillation occurs, the laser light from end surface of the self-oscillation semiconductor laser element is combined with an optical fiber 903 using an objective lens 902, and caused to enter an optical spectrum analyzer 904 where an emission spectrum is measured. By making the objective lens and the optical fiber scan in the direction parallel with the end surface and substrate, a peak value of the emission spectrum in each position is measured, and thus the oscillation wavelength for light emitting point position can be measured.

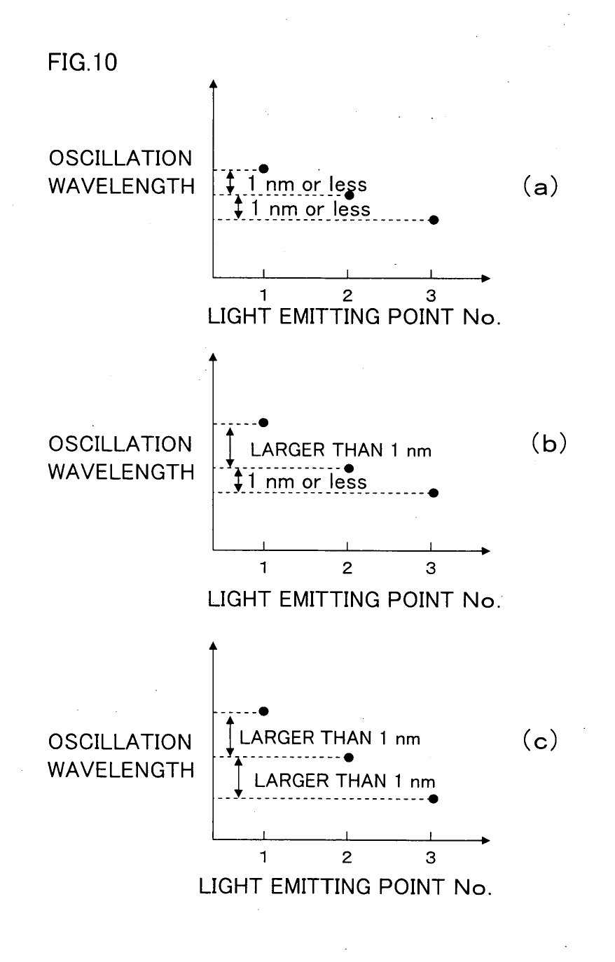

FIGS. 10(a), (b) and (c) are examples of plots of the oscillation wavelengths with respect to each position of the light emitting point, using a measuring system shown in FIG. 9, for a conventional-type (using semiconductor laser element lacking self-oscillation) light-emitting device having three light emitting points. Here, (a), (b) and (c) are measurement examples for different rots of conventional-type light-emitting devices, and show marked three examples for description. FIG. 10(a) shows an example in which a difference in the oscillation wavelengths between neighboring positions of the light emitting points is all 1 nm or less, FIG. 10(b) shows an example in which combination where a difference in the oscillation wavelengths between neighboring positions of the light emitting points is 1 nm or less and combination thereof is more than 1 nm are mixed, and FIG. 10(c) shows an example in which a difference in the oscillation wavelengths between neighboring positions of the light emitting points is all more than 1 nm. Here, three light emitting points correspond to outgoing end surface of each stripe in the light-emitting device on which the array-type self-oscillation semiconductor laser element is mounted as is the case of Example 1, or correspond to outgoing end surface of stripe possessed by each self-oscillation semiconductor laser element in the light-emitting device on which a plurality of self-oscillation semiconductor laser elements are mounted as is the case of Example 3.

Among FIGS. 10(a), (b) and (c), in (a) and (b), a far field pattern having a multi peak shape as shown in FIG. 7(b) was observed. Further, a conventional-type light-emitting device using a semiconductor laser element lacking self-oscillation and made up of a plurality of arrays was examined, and it was found that when there is at least one combination where the wavelength difference is 1 nm or less in the laser light from a plurality of the light emitting points, a far field pattern having a multi peak shape as shown in FIG. 7(b) is observed. However, in the light-emitting device of the present invention using a self-oscillation semiconductor laser element, even when there was a combination where the wavelength difference is 1 nm or less in the laser light from a plurality of the light emitting points, the far field pattern having a multi peak shape as shown in FIG. 7(b) was not observed. This proves that the effect of the present invention is significant when there is at least one combination where the wavelength difference is 1 nm or less in the laser light from a plurality of light emitting points.

### Example 2

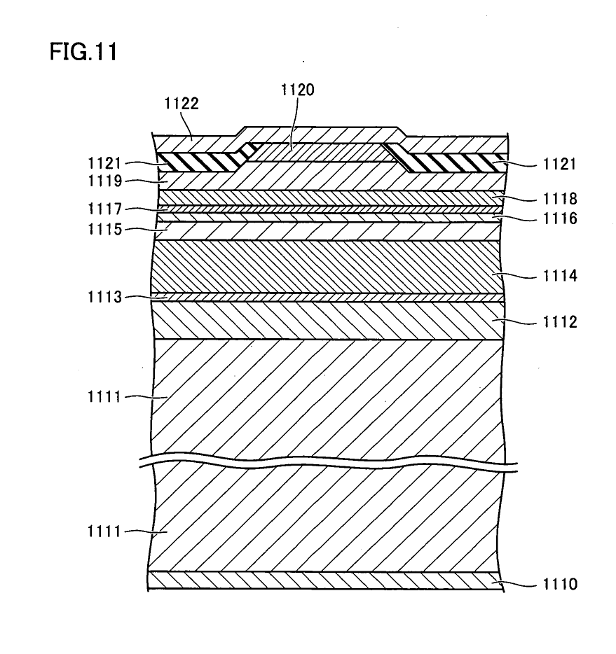

FIG. 11 is a section view of the self-oscillation semiconductor laser element according to Example 2 of the present invention, viewed from the stripe direction.

The nitride semiconductor laser element has a structure having a P type saturable absorbing layer, and includes an N electrode 1110, an n-GaN substrate 1111, an n-GaN layer 1112, an n-InGaN crack preventive layer 1113, an S.A. system 1114, an n-GaN guide layer 1115, an n-InGaN active layer 1116, a p-AlGaN carrier block layer 1117, a p-GaN guide layer 1118, a p-AlGaN clad layer 1119, a p-GaN contact layer 1120, an insulation film 1121, and a P electrode 1122, from the side of the substrate.

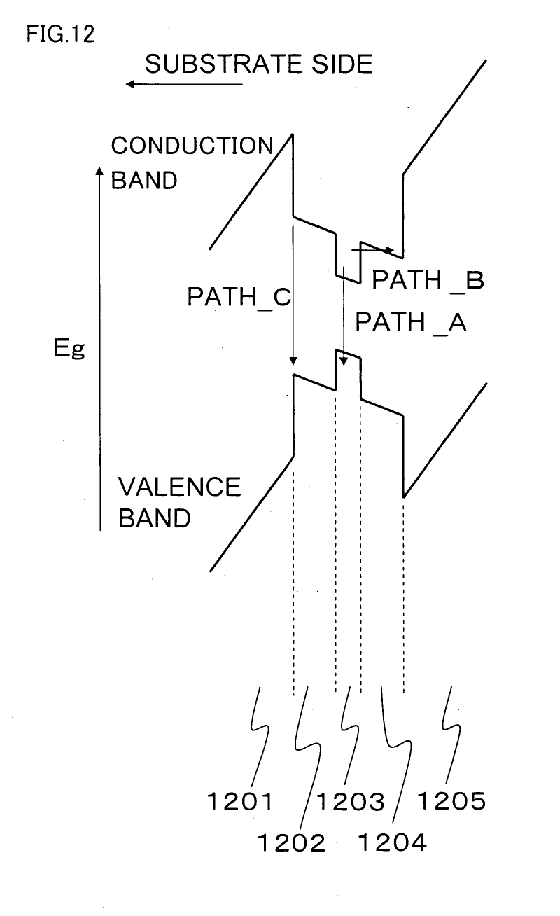

FIG. 12 shows the S.A. system of Example 2. From the side of the substrate, a first C.E. of n-AlGaN 1201, a second C.E. of InGaN 1202, an S.A. of InGaN 1203, a third C.E. of InGaN 1204, and a fourth C.E. of n-AlGaN 1205 are provided.

Example 2 has an identical form to Example 1 except that the laser element shown in FIG. 11 is used as a self-oscillation semiconductor laser element.

In Example 2, the effect similar to that of Example 1 is expected except that a minority carrier is a hole because an n-type saturable absorbing layer is used.

By fourth C.E. of AlGaN 1205,

dC.E.3+dS.A≦15 nm is preferred, and further,

dC.E.3+dS.A≦5 nm is more preferred.

By first C.E. of AlGaN 1201,

dC.E.2≦15 nm is preferred, And further,

dC.E.2≦5 nm is more preferred.

Within the above ranges, Path_B is expected by first C.E. 1201 and fourth C.E. 1205.

The composition of Al of first C.E. of AlGaN 1201 and fourth C.E. of AlGaN 1205 is preferably 0.1 or more, and more preferably 0.15 or more. The layer thickness of fourth C.E. of AlGaN 1205 is preferably 5 nm or more, and as a result of this Path_B can be expected.

Since first C.E. of AlGaN 1201 also serves as a clad layer, the layer thickness thereof is as thick as 0.5 μm or more. In order to control radiation mode to substrate, 1.0 μm or more is desired.

In the S.A. system of FIG. 12, third C.E of InGaN 1204 may be of GaN; thin GaN may be inserted between fourth C.E. of AlGaN 1205 and third C.E. of InGaN 1204; GaN may be inserted between third C.E. of InGaN 1204 and S.A. of InGaN 1203; and GaN may be inserted between second C.E. of InGaN 2 and first C.E. of AlGaN 1.

### Example 3

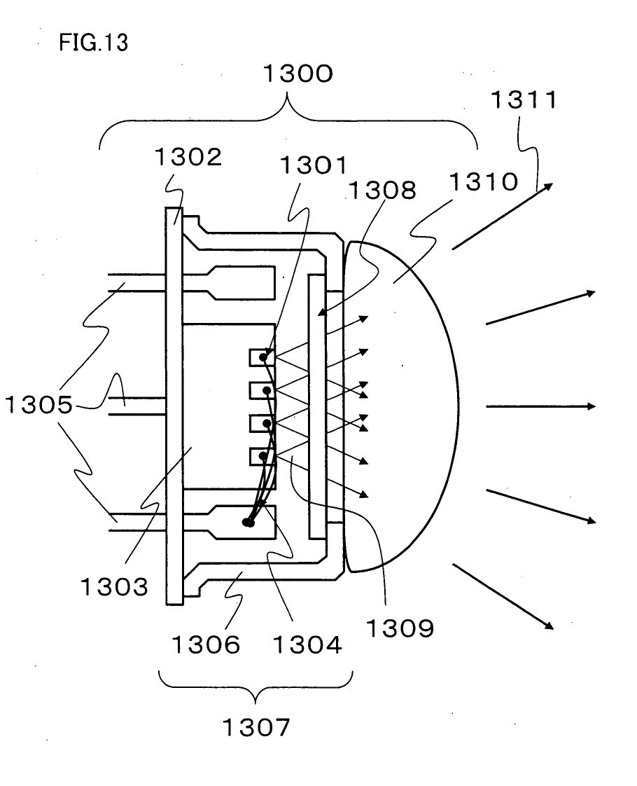

FIG. 13 is a schematic section view showing the light-emitting device according to Example 3 of the present invention.

An array-type self-oscillation semiconductor laser element 1301 is mounted on a block 1303 that is formed integrally with a stem 1302. The array-type self-oscillation semiconductor laser element is connected with a pin 1305 that is formed integrally with the stem via a wire 1304, and the array-type self-oscillation semiconductor laser element can be energized by supplying electric power to the pin from outside of the light-emitting device. The array-type self-oscillation semiconductor laser element is arranged inside a space 1307 that is hermetically sealed by a cap 1306. However, the cap is provided with a transmission window 1308 made of a glass, and as a result, a laser light 1309 emitted from the array-type self-oscillation semiconductor laser element is released outside the hermetically sealed space through the transmission window. Further, a phosphor 1310 is arranged outside the cap, and the phosphor is irradiated with most of the laser light, where the laser light is absorbed and converted into a fluorescent light 1311, and released outside.

Example 3 is similar to Example 1 except that a plurality of the self-oscillation semiconductor laser elements are mounted on the block. Also in the light-emitting device of Example 3, there are a plurality of the light emitting points of the laser light, and in this point, Example 3 is similar to Example 1. As for principle and effect, Example 3 is similar to Example 1.

In Example 3, each of the plurality of the self-oscillation semiconductor laser elements may be an array-type self-oscillation semiconductor laser element, or a self-oscillation semiconductor laser element shown in FIG. 2, and the same principle and effect are applicable.

### Example 4

Example 4 is a specific example of the light-emitting device shown in FIG. 2.

A first feature of Example 4 lies in that the oscillation wavelength of the self-oscillation semiconductor laser element is within the range of 420 to 500 nm, and a second feature lies in that combination of a phosphor differs in accordance with the oscillation wavelength, and a third feature lies in that a part of the laser light to enter the phosphor from the self-oscillation semiconductor laser element is intentionally caused to transmit, and the white light is produced together with the fluorescent light from the phosphor.

Description of a method for producing a light-emitting device of Example 4 will not be given because it is similar to the above except for adjusting crystal mixing ratio of In at the time of the active layer growth so that the oscillation wavelength is within the above range, changing the combination of the phosphor, and changing the shape of the phosphor for causing intentional transmission of the laser light.

As the combination of the phosphor, a phosphor that emits a light of a color complementary to blue of the laser light is preferred, and for example, yttrium/aluminum/garnet (YAG) phosphor (yellow) and α-SiAlON:Eu (yellow) can be recited.

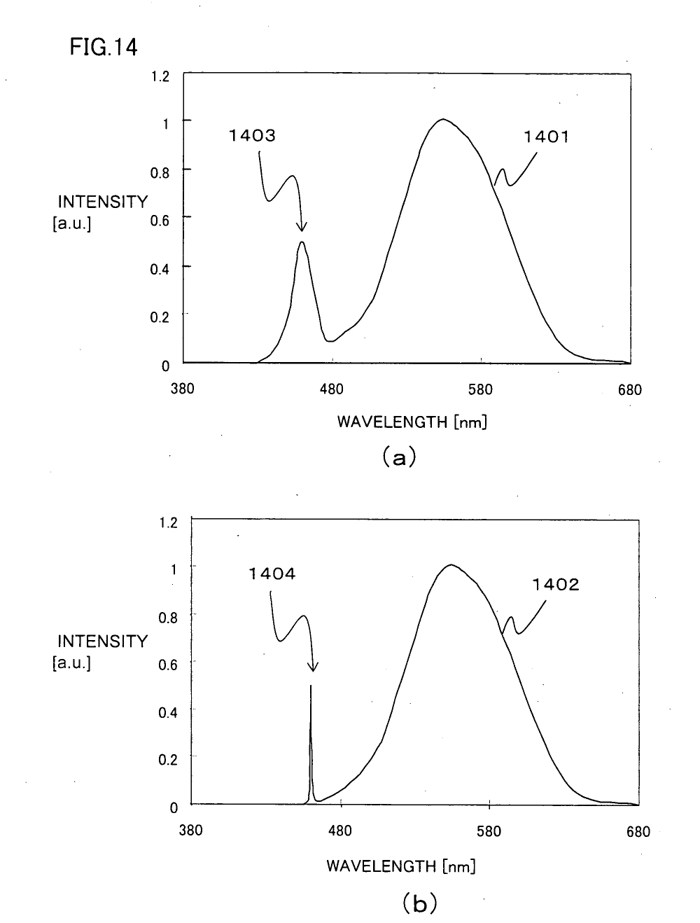

FIG. 14 shows an emission spectrum of a light-emitting device. In (a), 1401 indicates an emission spectrum of the light-emitting device in Example 4. In (b), 1402 indicates an emission spectrum of a conventional type light-emitting device (using a semiconductor laser element lacking self-oscillation).

In emission spectrum 1402 of the conventional type light-emitting device, a steep spectrum shape 1404 resulting from the laser light from the semiconductor laser element occurs in a wavelength band of 400 to 500 nm, and deteriorates the color rendering index. In contrast to this, in emission spectrum 1401 of the light-emitting device in Example 4, an emission spectrum 1403 from the semiconductor laser element is widened, and the color rendering index is improved. This is because the spectrum line width of the laser light is widened due to change into multi-lateral mode because a self-oscillation semiconductor laser element is used in the light-emitting device of the present invention, and this is truly the effect of the present invention.

A light radiated from the light-emitting device of Example 4 was projected onto a screen, and great improvement in a speckle pattern was observed compared to a conventional-type light-emitting device. This is because in the light-emitting device of the present invention, part of the laser light transmits and is taken outside the light-emitting device, and the coherence of the laser light is reduced, and is truly the effect of the present invention.

### Example 5

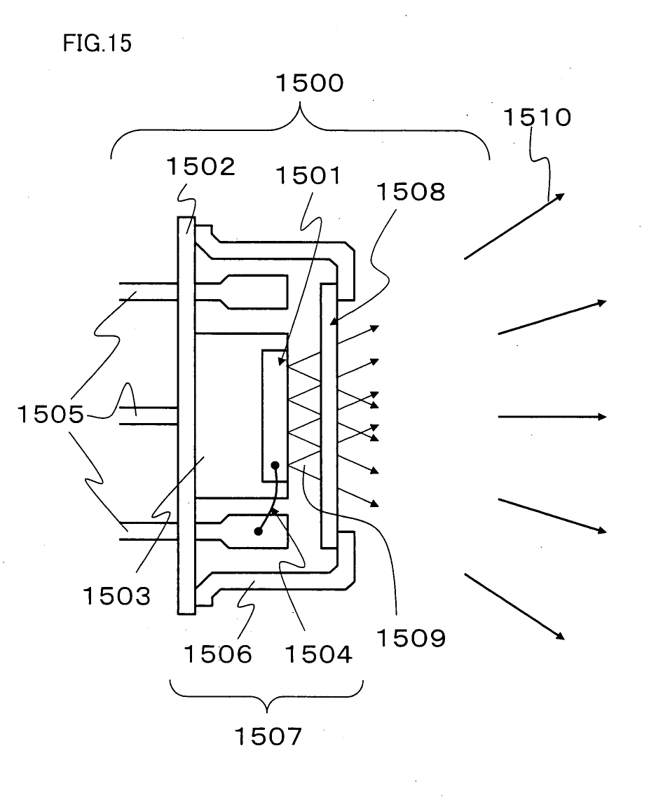

FIG. 15 is a schematic section view showing the light-emitting device of Example 5.

An array-type self-oscillation semiconductor laser element 1501 is mounted on a block 1503 that is formed integrally with a stem 1502. The array-type self-oscillation semiconductor laser element is connected with a pin 1505 that is formed integrally with the stem via a wire 1504, and the array-type self-oscillation semiconductor laser element can be energized by supplying electric power to the pin from outside of the light-emitting device. The array-type self-oscillation semiconductor laser element is arranged inside a space 1507 that is hermetically sealed by a cap 1506. However, the cap is provided with a transmission window 1508 made of a glass, and as a result, a laser light 1509 emitted from the array-type self-oscillation semiconductor laser element is released outside the hermetically sealed space through the transmission window. Further, in Example 5, a phosphor is mixed in the glass part. The phosphor is irradiated with most of the laser light, where the laser light is absorbed and converted into a fluorescent light 1510, and released outside.

Example 5 is featured in that the phosphor material is mixed into the glass part of the cap compared to Example 1.

The principle and effect are as same as that in Example 1.

In Example 5, as the self-oscillation semiconductor laser element, the self-oscillation semiconductor laser element shown in Example 2 may be used, or a plurality of self-oscillation semiconductor laser elements may be mounted as is in a case of Example 3, or likewise in Example 4, the oscillation wavelength may be from 420 to 500 nm, and a part of the laser light to enter the phosphor from the self-oscillation semiconductor laser element may be intentionally transmitted, to cause generation of the white light together with the fluorescent light from the phosphor.

In the above, examples of the present invention have been described, however, the scope of the present invention is not limited to the above, but is defined by the claims.

In each of the examples, an n-GaN substrate is used as the substrate of a self-oscillation semiconductor laser element used for a light-emitting device, however, it is not limited thereto and a sapphire substrate, an AlN substrate, a SiC substrate and the like may be used.

In each of the examples, a low-temperature GaN buffer layer, an n-InGaN crack preventive layer, an n-GaN guide layer, a p-GaN guide layer, and a p-GaN contact layer are not essential requirement. These may not be given, or may be replaced with a material made of another nitride semiconductor.

While a ridge structure is formed in the semiconductor laser element in each of the above examples, the structure is not limited to this insofar as an optical waveguide structure is formed. For example, a generally known self aligned structure (SAS), an electrode stripe structure, a buried hetero (BH) structure, a channeled substrate planar (CSP) structure or the like may be used irrespectively of the entity of the present invention and will provide a similar effect as described above.

While a structure applying the S.A. is shown as a method of causing self-oscillation of the self-oscillation semiconductor laser element in each of the above examples, an effect of the present invention arises if only the self-oscillation occurs in the semiconductor laser element at the time of an operation of the light-emitting device, and an weakly index guided (WI) structure may be alternatively employed wherein a saturable absorbing region is provided inside the active layer by setting light confinement in the direction perpendicular to a layer thickness be in an intermediate condition between index guide and gain guide.

The light-emitting device of the present invention is suited for use in a lighting apparatus or a display apparatus because it has excellent in output performance of the outgoing light and does not have the problem of light unevenness or the like.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A light-emitting device comprising:
a semiconductor laser element having at least a substrate, a first conductive type clad layer, an active layer, and a second conductive type clad layer at least in this order; and
a phosphor absorbing a laser light emitted from said semiconductor laser element and radiating fluorescence,
wherein said semiconductor laser element is a self-oscillation laser element.

2. The light-emitting device according to claim 1, wherein said semiconductor laser element includes a nitride semiconductor.

3. The light-emitting device according to claim 1, wherein said semiconductor laser element has an oscillation wavelength from 390 to 500 nM.

4. The light-emitting device according to claim 1, wherein said semiconductor laser element comprises at least a first conductive type intermediate layer and a first conductive type saturable absorbing layer between the first conductive type clad layer and the active layer from the side closer to the active layer.

5. The light-emitting device according to claim 1, wherein semiconductor laser element comprises at least a second conductive type intermediate layer and a second conductive type saturable absorbing layer between the active layer and the second conductive type clad layer from the side closer to the active layer.

6. A light-emitting device, wherein the semiconductor laser element according to claim 1 is an array-type semiconductor laser element.

7. The light-emitting device according to claim 6, wherein in laser light from a plurality of light emitting points, there is a combination where a wavelength difference is 1 nm or less.

8. A light-emitting device, comprising two or more semiconductor laser elements according to claim 1.

9. The light-emitting device according to claim 8, wherein in laser light from a plurality of light emitting points, there is a combination where wavelength difference is 1 nm or less.

10. A lighting apparatus utilizing the light-emitting device according to claim 1.

11. A display apparatus utilizing the light-emitting device according to claim 1.
